(19) United States
(12) Patent Application Publication
(10) Pub. No.: US 2017/0331960 A1
(43) Pub. Date: Nov. 16, 2017

(54) INMATE VOICE AND VIDEO CALL RATING SYSTEM AND METHOD

(71) Applicant: GLOBAL TEL*LINK CORP., Reston, VA (US)

(72) Inventors: Stephen Lee HODGE, Aubrey, TX (US); Garth JOHNSON, Indianapolis, IN (US); Krishna KOILADA, Houston, TX (US); Athar WAQAS, Vernon, CT (US); Michael D. BARTH, Purcellville, VA (US)

(21) Appl. No.: 15/151,232

(22) Filed: May 10, 2016

(51) Int. Cl. H04M 15/00; H04M 7/00; H04L 29/08

(52) U.S. Cl. CPC H04M 15/8055; H04M 15/8033; H04M 15/8016; H04L 67/12; H04M 15/56; H04M 7/006; H04M 15/60

(57) ABSTRACT

An inmate communication system and method of using are described herein for obtaining a lowest session rate. The inmate communication system includes a session boarder controller (SBC) server that analyses data from multiple carriers, historical sessions, and additional factors such as quality of service to determine a lowest rate for the session. The SBC server then routes the session using the carrier that has the determined lowest rate for the session. Further, the SBC server is configured to include both local and location redundancies to avoid interruptions in session service.

### BACKGROUND

### Field

The disclosure relates to a communication system that facilitates flat rate sessions between an inmate and a third party.

### Background

Traditional inmate call systems determine a cost of a call from a correctional facility based on collect calling surcharges, which uses an operator for assistance, and a rate per minute analysis, which is based on the mileage between a calling party and a call receiving party. These traditional inmate call systems work well using traditional public switched telephone networks (PSTNs) and when the calling party and the call receiving party have fixed locations and use plain old telephone services (POTSs). However, both calling and call receiving parties are increasingly utilizing data systems that make a determination of the mileage between these parties difficult, if not impossible.

### BRIEF DESCRIPTION OF THE DRAWINGS/FIGURES

The accompanying drawings, which are incorporated herein and form a part of the specification, illustrate embodiments of the present disclosure and, together with the description, further serve to explain the principles of the disclosure and to enable a person skilled in the pertinent art to make and use the embodiments.

FIG. 1 illustrates a block diagram of a communication system, according to exemplary embodiments of the present disclosure;

FIG. 2 illustrates a block diagram of a communication center, according to exemplary embodiments of the present disclosure;

FIG. 3 illustrates a block diagram of a communication server, according to exemplary embodiments of the present disclosure;

FIG. 4 illustrates a block diagram of a session boarder controller (SBC) server, according to exemplary embodiments of the present disclosure;

FIG. 5 illustrates a flowchart diagram of a method for routing a session, according to exemplary embodiments of the present disclosure;

FIG. 6 illustrates a flowchart diagram of a method for determining a rate for a session, according to exemplary embodiments of the present disclosure;

FIG. 7 illustrates a block diagram of a communication server having redundancies, according to exemplary embodiments of the present disclosure;

FIG. 8 illustrates a computer system, according to exemplary embodiments of the present disclosure.

The present disclosure will be described with reference to the accompanying drawings. In the drawings, like reference numbers indicate identical or functionally similar elements. Additionally, the left most digit(s) of a reference number identifies the drawing in which the reference number first appears.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment.” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this discussion, any reference to the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

### Overview

Communication between inmates and outsiders has been shown to be an extremely important part of rehabilitation. Allowing for an inmate to keep in contact with friends and family significantly helps to reduce recidivism as well as to prepare an inmate for life after prison. Because most inmates are eventually released back into the public, any steps to minimize problems with their re-assimilation with society are highly beneficial.

Traditional inmate call systems charge a calling party and a call receiving party a rate that was based on the cost of collect calling surcharges, which use an operator for assistance, and based on a rate per minute analysis, which uses a mileage between the calling party and the call receiving party. Traditional inmate call systems work well when the parties have fixed locations such as when both parties use plain old telephone services (POTSs). To encourage calls during a non-peak time, the inmate calling systems incentivize calls at nights and weekends by providing discounted costs. However, both parties, including those at correctional facilities, are increasingly utilizing data systems to place and receive calls. For correctional facilities, newer inmate call systems use voice over internet protocol (VoIP) based network systems that can be located at the correctional facilities to call and receive calls. For friends or family of inmates, calls are placed to or are received from cellular or internet protocol (IP) based phones. Use of IP based calls and cellular calls creates numerous challenges for determining a distance between the parties and, in some cases, does not allow for accurate cost analysis in traditional inmate call systems. For example, some inmate call systems attempt to use a global positioning system (GPS) associated with the called phone to correctly determine a rate of the calls, but this has limited availability. As another example, numerous calls from correctional facilities are to locations where the called number has been call forwarded and the mileage is extremely difficult to calculate. Further, almost all phone systems allow number portability, which makes traditional inmate phone systems that use vertical and horizontal coordinates to rate a call completely error prone.

In contrast to traditional communication systems, most modern communication providers for correctional facilities undergo a bidding process in order to provide communication services for a correctional facility. The bidding process provides a low fixed rate for inmates and families for the life of a contract, and typically includes all the costs necessary in providing a low rate. During the bidding process, the communication providers are, in general, required to indicate fixed rates which inmates will be charged per minute for any communications. Providers typically provide the following three tier rate plan to correctional facilities during the bidding process: (1) a domestic rate for an inmate to communicate with a party in the United States, (2) a North American rate for an inmate to communicate with a party located outside the United States but within North American territories such as Mexico and/or Caribbean Islands, and (3) international rates for an inmate to communicate with a party in a country outside of the first two tiers, where each country may have its own rate. When a bid is accepted by a correctional facility, the winning communication provider must provide the service at the fixed rates submitted during the bidding process. The bidding process allows inmates, and those who communicate with them, to have communications at a low fixed rate that has been competitively provided.

To continue to provide low fixed rates to inmates, and those that communicate with them, during the life of a contract, service providers must then seek ways to retain or bring down the actual cost of each communication by retaining or lowering base rates and session rates.

In light of the above, the present disclosure provides a system and method of obtaining a rate by an inmate communication system which includes a session boarder controller (SBC) server that analyses data from multiple carriers and historical sessions to determine the lowest rate for the session. Further, the SBC server is configured for both local and location redundancies to avoid interruptions in session service.

### Communication System

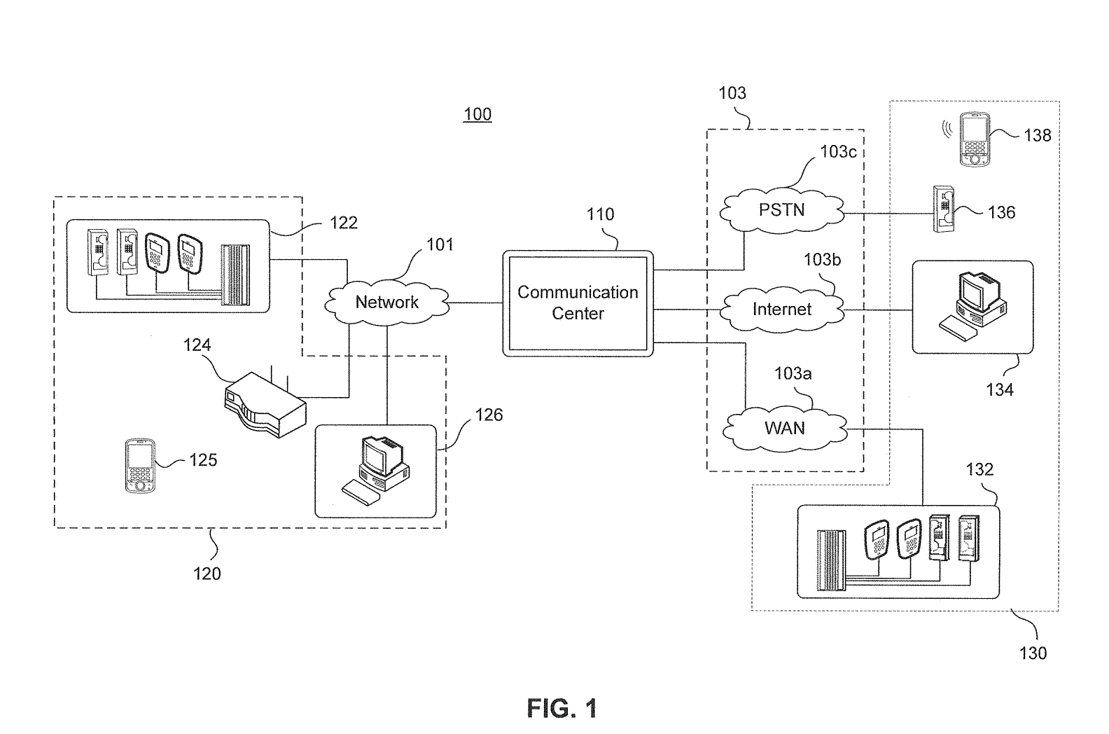

FIG. 1 illustrates a block diagram of a communication system 100, according to exemplary embodiments of the present disclosure. The communication system 100 includes a communication center 110 configured to communicate with a variety of devises over a variety of different communication networks. In particular, the communication center 110 is configured to receive a session from one of either an inmate communication device 120 or a communication device 130 and connect the session to the other. To communicate with the inmate communication device 120, the communication center 110 interfaces with a network 101. The network 101 may be any one or more of a local area network (LAN), a wide area network (WAN), or the internet. The inmate communication device 120 may interface with the network 101 by any or all devices such as audio and video communications device(s) 122, wireless device 125, and/or a control station 126. The communication center 110 is also configured to connect to a wireless access point 124 (e.g., a router), which may provide connectivity to the wireless device 125.

The communication device 130 may be any or all devices to which the inmate communication device 120 communicates with, such as audio and video communication device(s) 132 that are located at the same or another correctional facility, a control station 134, a telephone 136 and/or a cellular phone 138. The communication center 110 interfaces with the communication device 130 via a network 103 that includes any or all of a wide area network (WAN) 103a, the internet 103b, and a public switched telephone network (PSTN) 103c. The WAN 103a may facilitate communications with other nearby prisons, such as those within the same county, state, etc. The audio and video communication devices 132 located at those other facilities may provide cross-facility communications between inmates. In an embodiment, web real-time communications (WebRTC) may be utilized in place of an session initiation protocol (SIP) over the WAN or the internet, each of which provides a dedicated link between the inmate communication device 120 and the communication device 130.

The internet 103b is utilized to provide access to remote stations 134 such as remotely distributed control stations, scheduling clients, and home visitation devices. The PSTN 103c can be used to provide connectivity to basic telephones 136 and other communication devices, such as the cellular phone 138, over traditional data networks.

### Communication Center

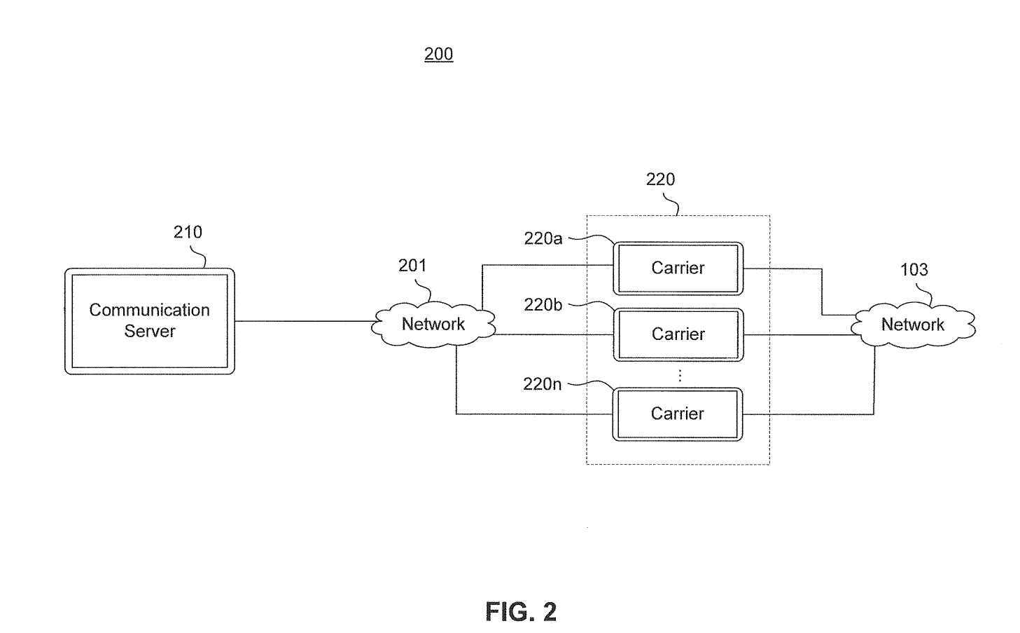

FIG. 2 illustrates a block diagram of a communication center 200, according to exemplary embodiments of the present disclosure. The communication center 200 may be an exemplary embodiment of the communication center 110 of FIG. 1. The communication center 200 includes a communication server 210 which communicates with carriers 220. The communication server 210 interface with the carriers 220 via a network 201, such as internet or a WAN. The carriers 220 may include carriers that actually own phone carrier equipment (e.g., AT&T or Verizon) and/or wholesalers that have purchased an amount of session minutes for resale from the actual carriers. Further, the carriers 220 may include any or all types of communication carriers such as physical telephone line providers, voice over internet protocol (VoIP) providers, wireless providers, session internet protocol (SIP) providers, and/or video communication providers.

The communication server 210 is configured to receive base rates from the carriers 220, including carriers 220a-220n, for connection of a session between the inmate communication device 120 and the communication device 130. Accordingly, a base rate, according to this disclosure, is a rate charged by a carrier for transporting a session. In providing base rates, the carriers 220 provide to the communication server 210 rates for a session using the carriers 220 equipment and/or equipment with which the carriers 220 have contract to use. For example, the communication server 210 can receive base rates from the carrier 220a that are for the northeast region of the United States, where the carrier 220a owns physical phone lines, and can receive base rates from the carrier 220a for the southwest region of the United States, where the carrier 220a does not own physical phone lines but has a contract with the carrier 220b to provide communication service. Further to this example, communication server 210 may also receive base rates for the southwest region of the United States from the carrier 220b.

The communication server 210 is further configured to connect a session between the inmate communication device 120 and the communication device 130 by way of the carriers 220. For example, after receiving base rates from carrier 220a, the communication server 210 may send a session from the audio communication device 122 the carrier 220a who then routes the session to telephone 136 by way of a physical phone line owned by carrier 220a.

### Communication Server

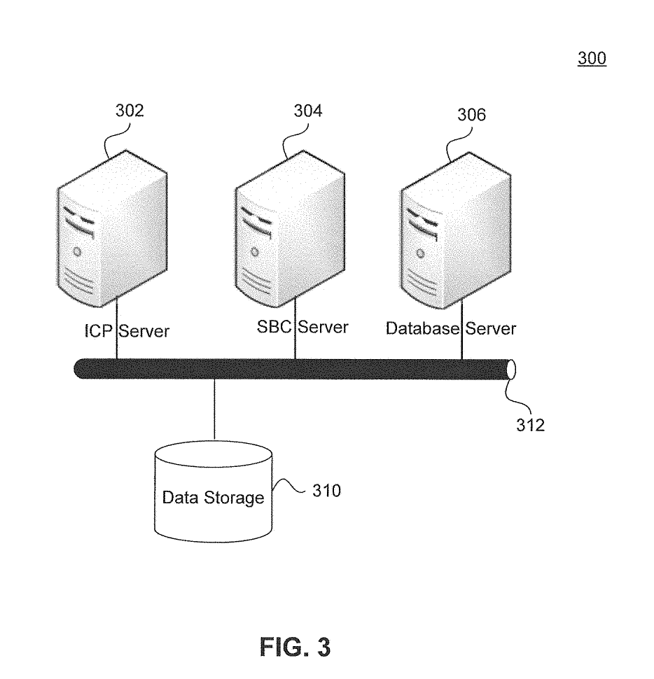

FIG. 3 illustrates a block diagram of a communication server 300, according to exemplary embodiments of the present disclosure. The communication server 300 may represent an exemplary embodiment of the communication server 210. The communication server 300 includes an inmate communication processor (ICP) server 302, a session boarder controller (SPC) server 304, a database server 306, and data storage 310, that are all connected to each other via a network bus 312.

Each of the servers 302-306 can be constructed as individual physical hardware devices, or as virtual servers. The number of physical hardware machines can be scaled to match the number of simultaneous user connections desired to be supported in an inmate communication system such as the inmate communication system 100.

The ICP server 302 can consist of any number of servers, and is configured to screen session s before a session is created. In essence, the ICP server 302 is configured to facilitate a secure communication between the parties by performing initial screening and verification of the parties involved. For example, the ICP server 302 may be used to verify the identity of the parties involved in a session by way of pin verification, biometric verification, and/or location verification.

The session boarder controller (SBC) server 304 can consist of any number of servers, and is configured to control a session, or a call, between the parties such as the inmate communication device 120 and the communication device 130. In detail, the SBC server 304 performs switching required to electrically connect two or more parties together for a session. In an embodiment, the SBC server 304 determines how to route a session. For example, the SBC server 304 can determine how to route a session within the communication center to or from an inmate communication device 120 and can determine which of the carriers 200 will be used to route the session to or from the communication device 130. The SBC server 304 also controls the signaling message exchanges and session streams that occur during the session. The SBC server 304 further provides abilities for a session to be routed through the communication center 110 by assisting in the flow of audio or voice data and session information such as session statistics and session quality within the communication center 110.

The database server 306 can consist of any number of servers, and is configured to obtain, organize, and maintain information relating to the carriers 200 and information relating to base rates provided by the carriers 200. In detail, the database server 306 receives information related to base rates from the carriers 200, updates information related to the base rates, and indexes the information such that the information may be searched through, sorted, and/or viewed. For example, the database server 306 may receive rate information regarding such information as routing costs for sessions and contract costs between a correctional facility and a carrier, and the database server 306 can update the base rates such that a table may be viewed having the base rates of all the carriers 220 sorted by the lowest base rate. The database server 306 is also configured to receive and store quality information related to a carrier. The quality information may include service quality information such as quality of service (QOS) and mean opinion score (MOS) information, information obtained by quality tests performed on historical bases, surveys received from inmates or outsiders performed during the historical bases, or information obtained from the carriers 220a-220n regarding scheduled connection maintenance. In an embodiment, the quality information can include the R-factor which is a quantitative value to express the quality of experience of a session over VOIP on a network. The R-factor is an alternative to the MOS. In particular, the R-factor is based on a scale that ranges from 0-120, where a score of 50 and below is considered poor quality, and a score above 90 is considered excellent quality. The R-factor is derived based on both objective qualities, such as latency, jitter, and packet loss, and subjective qualities, such as user perceptions. The database server 306 is further configured to index the quality information, and link the quality information with the base rates of the carrier routing the session.

In an embodiment, the database server 306 is also configured to store additional information that may affect a session rate. The session rate is the overall rate of session based on the base rate and additional fees. The additional factors that can affect the rate of a session include whether the session is an international session, whether a correctional facility includes a fee, whether a jurisdiction within which the correction facility is located includes a fee, whether the session is a video or voice session, whether a deposit account is being used for the session, whether deposit account rewards are being used for the session, and/or whether an interactive voice setup or a live operator assistance was used for the deposit account.

In an embodiment, the database server 306 is also configured to base a session rate on a local routing number (LRN). The LRN is unique number that represents a switch through which communications are routed. The LRN is used to determine routing decisions of a communication without the use of a phone number used by one of the communication devices 120 or 130. Instead, an LRN is used to map local access and transport areas, which are areas within which a company is permitted to offer routing services, and originally called numbers. For example, when an inmate communication device attempts to initiate a communication with a communication device 130, the database server 306 determines a session rate based on routing the call to the LRN associated with the phone number and not to the location of the phone number.

In an embodiment, the database server 306 is also configured to base a session rate on a last mile score. In detail, the last mile refers to the physical portion of routing between a network and the actual communication device. In one example, the last mile refers to the actual copper wire that connects between a switch and a telephone. In another example, the last mile refers to the coaxial cable between the switch and an access point. Thus, the term mile is not used in the literal sense. In general, communications on a network have a significant amount of bandwidth. However, when a communication reaches the last mile, issues such as limited bandwidth due to technology (e.g., copper wire or coaxial cable) cause communications to bottleneck. The last mile score is a score that takes into account these issues caused by the last mile. In particular, the last mile score takes into account when quality information related to a carrier is low due to the last mile technology by comparing the quality issues of the carrier with other carriers that provide or have provided service to a particular location. In doing so, carriers are not penalized because of the limitations of the last mile.

The database server 306 can store all information on a local storage and/or the data storage 310. The database server 306 is configured to transmit stored information to the SBC server 304 or allow the stored information to be retrieved by the SBC server 304.

The data storage 310 provides access to a wide variety of data such as party identification, session scheduling data, and/or any data stored by the ICP server 302, the SBC server 304, and the database server 306. Because the data stored on the data storage 310 may consume a significant amount of storage space, the data storage 310 may include a Network Attached Storage (NAS) device, which may be configured as a mass storage device. In order to reduce an amount of data stored, the data storage 310 preferably includes a backup routine to transfer data to permanent storage devices, such as archival permanent storage or optical disks, after a predetermined time has elapsed since the initial recording of that data. The storage device 310 is connected to ICP server 302, the SBC server, and the database server 206 by way of the network bus 312.

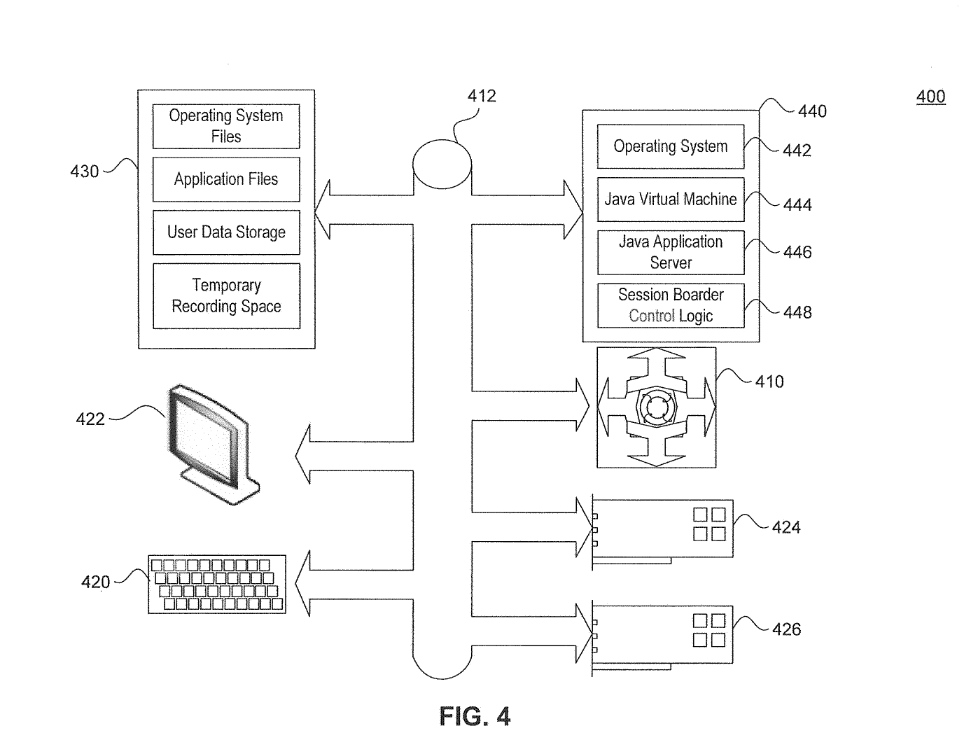

FIG. 4 illustrates a block diagram of an SBC server 400, according to exemplary embodiments of the present disclosure. The SBC server 400 may represent an exemplary embodiment of the SBC server 304 depicted in FIG. 3. The SBC server 400 functions as the primary logic processing center in the communication system 100. The SBC server 400 includes one or more central processing units (CPU) 410 connected via a bus 412 to several other peripherals. Such peripherals include an input device, such as a keyboard and/or mouse 420, a monitor 422 for displaying information, a network interface card 424 and/or a modem 426 that provide network connectivity and communication.

The SBC server 400 also includes internal data storage 430. This data storage 430 is non-volatile storage, such as one or more magnetic hard disk drives (HDDs) and/or one or more solid state drives (SSDs). The data storage 430 is used to store a variety of important files, documents, or other digital information, such as the operating system files, application files, user data, and/or temporary recording space.

The SBC server 400 also includes system memory 440. The system memory 440 is preferably faster and efficient than the data storage 430, and is configured as random access memory (RAM) in an embodiment. The system memory 440 contains the runtime environment of the application server, storing temporary data for any of the operating system 442, java virtual machine 444, java application server 446, and session boarder control logic 448.

### Communication Center Operation

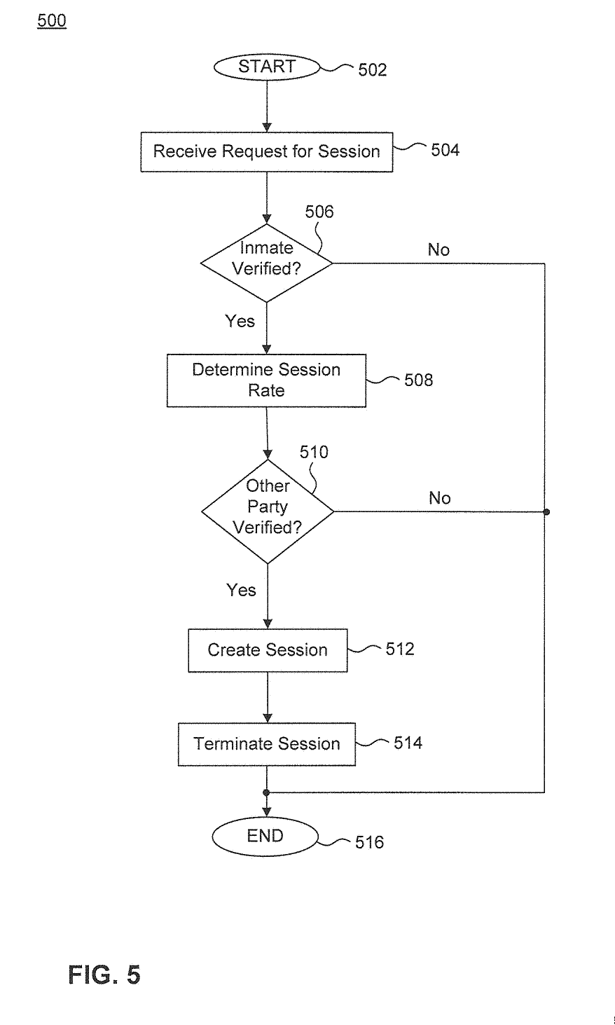

An operation of the communication center 110 will be described with respect to FIG. 5, which illustrates a flowchart diagram of a method 500 for routing a session, according to exemplary embodiments of the present disclosure. Although the physical devices and components that form the operation have largely already been described, additional details regarding their more nuanced operation will be described below with respect to FIGS. 1-4.

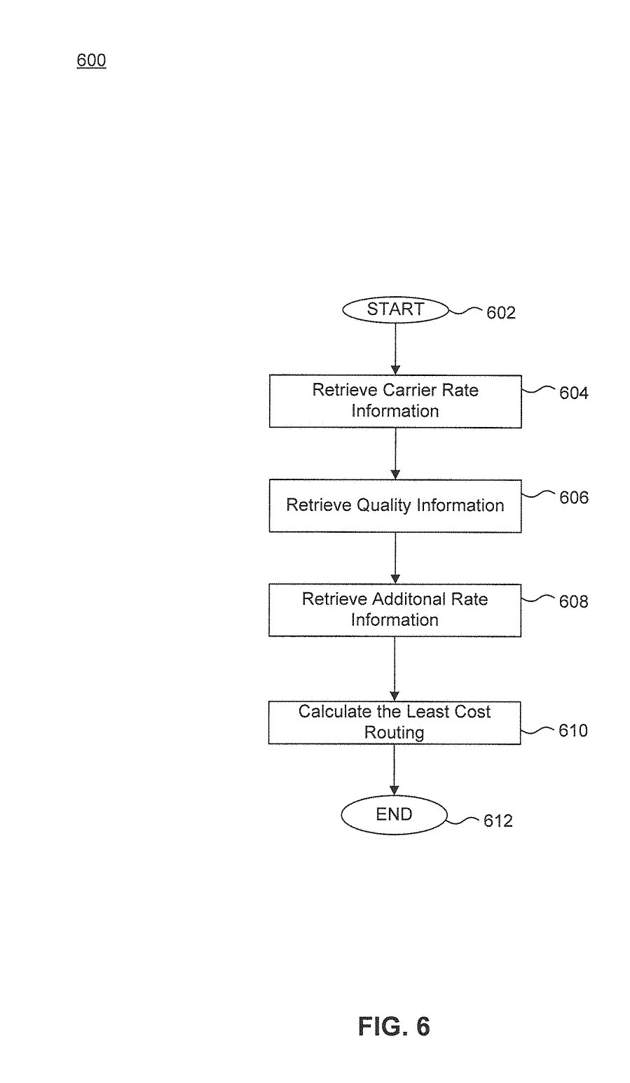

When one of an inmate communication device 120 or a communication device 130 makes a connection to the communication center 110, a session process begins (502). After the session process begins, the communication server 210 receives a request to start a session from the one of an inmate communication device 120 or a communication device 130 (504). For example, the ICP server 302 of the communication server 300 may receive a request to start a session from an inmate communication device 120 and retrieve information associated with an inmate initiating the session and the other party involved in the session. The ICP server 302 then performs a verification to determine that the identity of the person initiating the session is in fact the correct inmate (506). The identity of the person initiating the session is verified by comparing the received information associated with person initiating the session and the identity data stored by the ICP server 302. If the identity verification fails, the session process ends (516). If the identity verification passes, the information associated with the inmate initiating the session and the other party is transmitted to the SBC server to determine a rate for transporting the session (508), which is described below in further detail with respect to FIG. 6.

Once the rate has been determined, the identity of the other party is verified (510). If the communication center 110 is unable to verify the identity of the other party, the session process ends (516). If the other party is verified, then a session is created between the inmate communication device 120 and the outsider communication device 130 (512). At some later time, either the inmate communication device 120 or the outsider communication device 130 terminates the session (514). In an embodiment, SBC server 304 can gather information on the quality and/or the connection availability of the carrier service. The information may be gathered throughout the session and/or an inmate or the outsider may have an opportunity to provide feedback on the quality of the service. The session process then ends (516).

### Rate Determination Operation

An operation of the SBC server 304 will be described with respect to FIG. 6, which illustrates a flowchart diagram of a method 600 for determining a rate for transporting a session, according to exemplary embodiments of the present disclosure. The method may represent an exemplary embodiment of the determining of the rate for transporting the session (508) of FIG. 5. Although the physical devices and components that form the operation have largely already been described, additional details regarding their more nuanced operation will be described below with respect to FIGS. 1-5.

When the SBC server 304 receives information from the ICP server 302 a rate determination process begins (602). The SBC server 304 analyzes the information regarding the inmate and the outsider, and the SBC server 304 retrieves carrier rate information from the database server 306 to determine which carrier provides the lowest transport and termination costs for the session (604). The rate information from the database server 306 includes information regarding contract costs with the carriers or most direct routing used by the carriers to create the session. Next, the SBC server retrieves quality information from the database server 306 (606). For example, SBC server can retrieve information regarding a maintenance service being performed by the carrier 220a that would affect a quality of the session. Once the quality information is retrieved, the SBC server 304 retrieves additional rate information from the database server 306 (608). After all the information has been gathered, the SBC server 304 calculates a rate for the session based on the rate information, the quality information, and the additional information (610), and the rate determination process ends (612).

### Session Boarder Controller Server Redundancies

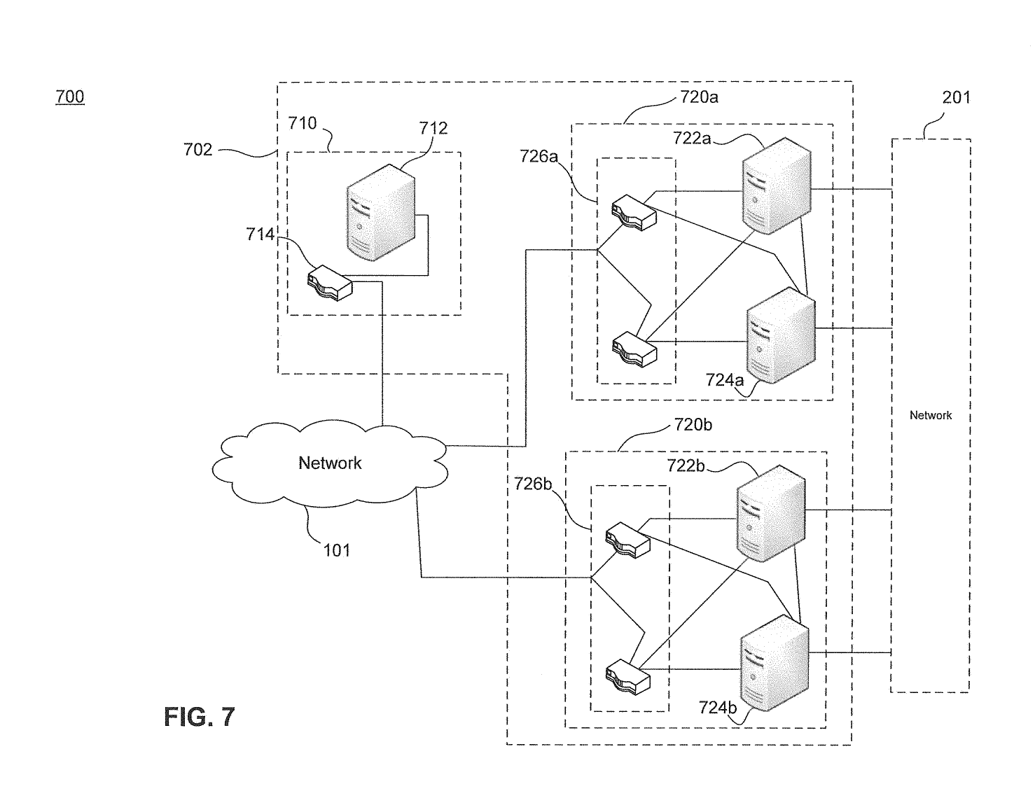

FIG. 7 illustrates a block diagram of a communication system 700 having redundancies, according to exemplary embodiments of the present disclosure. In an embodiment, the communication system 700 includes a communication server 702, which may be an exemplary embodiment of the communication server 210.

The communication server 702 includes an ICP server 710 and at least two SBC servers 720a and 720b. The ICP server 710 may be an exemplary embodiment of the ICP server 302 of FIG. 3, and the SBC servers 720a and 720b may be exemplary embodiments of the SBC server 304 of FIG. 3. The ICP server 710 includes a computer system 712 connected to an access point 714, which connects to the internet 101.

In an embodiment, the SBC servers 720a and 720b are configured to provide location redundancy. Accordingly, the SBC servers 720a and 720b are be located at different locations. For example, the SBC server 720a may be located in Texas, and the SBC server 720b may be located in Virginia. In doing so, when one of the servers 720a or 720b goes offline, the ICP server 710 can route a session to the online server (either server 720a or 720b) and all tasks are performed by the online server.

Further, the SBC servers 720a and 720b are also configured to provide local redundancy. Accordingly, the SBC server 720a includes servers 722a and 724a and at least one switch 726a, and the SBC server 720b includes servers 722b and 724b and at least one switch 726b. The switches 726a and 726b are configured to distribute sessions between respective servers 722a, 724a, 722b, and 724b. Further, the servers 722a and 724a are aware of each other such that when either one of the servers 722a or 722b goes offline, the other can receive a session and perform all operations. The servers 722b and 724b are similarly aware of each other.

By providing dual redundancies, both location based and local based as described above, there are at least two communication server locations (e.g., 720a and 720b) each of which includes at least two SBC servers (e.g., 722a, 724a and 722b, 724b) that are connected to multiple carriers (e.g., 220a-220n) serving each location through a distributed cloud based clustered call processor (e.g., 710) which means there is no single point of failure at the communication server 702.

### Exemplary Computer Implementation

It will be apparent to persons skilled in the relevant art(s) that various elements and features of the present disclosure, as described herein, can be implemented in hardware using analog and/or digital circuits, in software, through the execution of computer instructions by one or more general purpose or special-purpose processors, or as a combination of hardware and software.

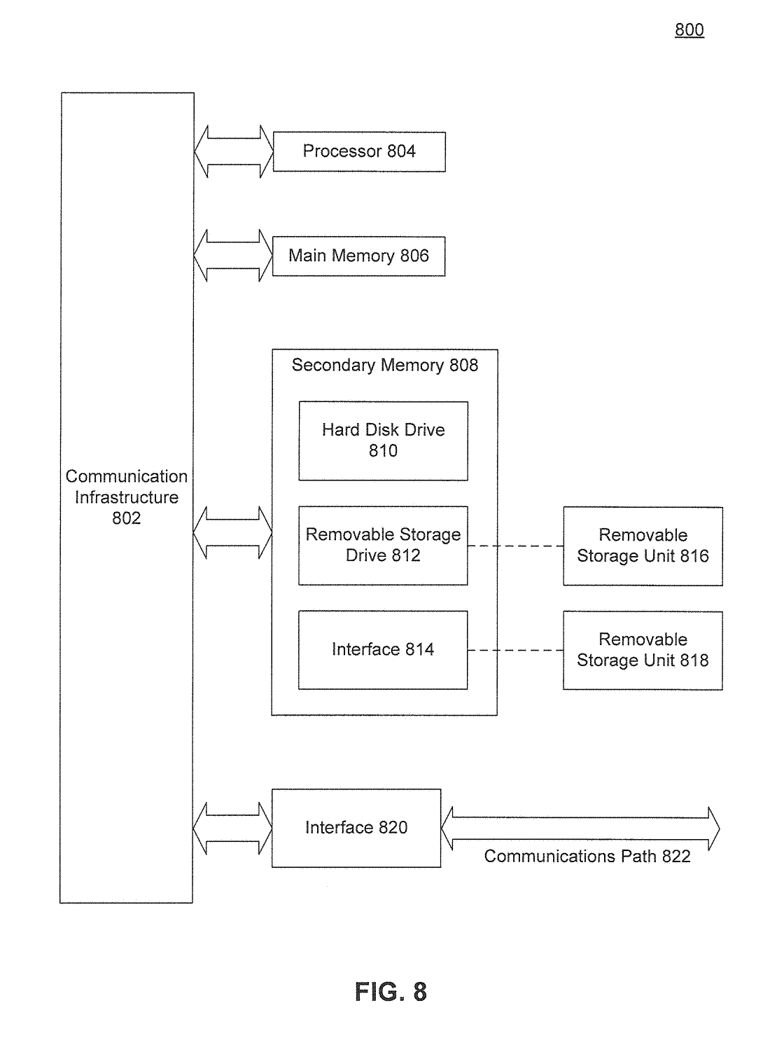

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. For example, the methods of FIGS. 5 and 6 can be implemented in the environment of one or more computer systems or other processing systems. An example of such a computer system 800 is shown in FIG. 8. One or more of the modules depicted in the previous figures can be at least partially implemented on one or more distinct computer systems 800.

Computer system 800 includes one or more processors, such as processor 804. Processor 804 can be a special purpose or a general purpose digital signal processor. Processor 804 is connected to a communication infrastructure 802 (for example, a bus or network). Various software implementations are described in terms of this exemplary computer system. After reading this description, it will become apparent to a person skilled in the relevant art(s) how to implement the disclosure using other computer systems and/or computer architectures.

Computer system 800 also includes a main memory 806, preferably random access memory (RAM), and may also include a secondary memory 808. Secondary memory 808 may include, for example, a hard disk drive 810 and/or a removable storage drive 812, representing a floppy disk drive, a magnetic tape drive, an optical disk drive, or the like. Removable storage drive 812 reads from and/or writes to a removable storage unit 816 in a well-known manner. Removable storage unit 816 represents a floppy disk, magnetic tape, optical disk, or the like, which is read by and written to by removable storage drive 812. As will be appreciated by persons skilled in the relevant art(s), removable storage unit 816 includes a computer usable storage medium having stored therein computer software and/or data.

In alternative implementations, secondary memory 808 may include other similar means for allowing computer programs or other instructions to be loaded into computer system 800. Such means may include, for example, a removable storage unit 818 and an interface 814. Examples of such means may include a program cartridge and cartridge interface (such as that found in video game devices), a removable memory chip (such as an EPROM, or PROM) and associated socket, a thumb drive and USB port, and other removable storage units 818 and interfaces 814 which allow software and data to be transferred from removable storage unit 818 to computer system 800.

Computer system 800 may also include a communications interface 820. Communications interface 820 allows software and data to be transferred between computer system 800 and external devices. Examples of communications interface 820 may include a modem, a network interface (such as an Ethernet card), a communications port, a PCMCIA slot and card, etc. Software and data transferred via communications interface 820 are in the form of signals which may be electronic, electromagnetic, optical, or other signals capable of being received by communications interface 820. These signals are provided to communications interface 820 via a communications path 822. Communications path 822 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 816 and 818 or a hard disk installed in hard disk drive 810. These computer program products are means for providing software to computer system 800.

Computer programs (also called computer control logic) are stored in main memory 806 and/or secondary memory 808. Computer programs may also be received via communications interface 820. Such computer programs, when executed, enable the computer system 800 to implement the present disclosure as discussed herein. In particular, the computer programs, when executed, enable processor 804 to implement the processes of the present disclosure, such as any of the methods described herein. Accordingly, such computer programs represent controllers of the computer system 800. Where the disclosure is implemented using software, the software may be stored in a computer program product and loaded into computer system 800 using removable storage drive 812, interface 814, or communications interface 820.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the invention should not be limited by any of the above-described exemplary embodiments, but should be defined only in accordance with the following claims and their equivalents.

What is claimed is:

1. An inmate communication system, comprising:
a database server configured to receive carrier rates from a plurality of carriers and to store the carrier rates; and
a session boarder controller (SBC) server configured to:
receive session data;
receive the stored carrier rates and to determine a lowest session rate based on the session data and the stored carrier rates;
route a session based on the determined lowest session rate.

2. The inmate communication system of claim 1, wherein the stored carrier rates include information regarding contracted rates between a correctional facility and carriers.

3. The inmate communication system of claim 2, wherein the stored carrier rates further include information regarding session routing of the carriers.

4. The inmate communication system of claim 1, wherein the database server is further configured to store quality of service data, and wherein the SBC server is further configured to determine the lowest session rate based on the quality of service data.

5. The inmate communication system of claim 4, wherein the database server is further configured to obtain the quality of service data by performing at least one of quality tests on previous sessions, quality surveys of previous sessions, or carrier provided data.

6. The inmate communication system of claim 5, wherein the database server obtains and updates stored quality of service data after a session is ended.

7. The inmate communication system of claim 1, wherein the database server is further configured to store additional data, and wherein the SBC server is further configured to determine the lowest session rate based on the additional session data.

8. The inmate communication system of claim 7, wherein the additional session data is at least one of correction facility fees, jurisdictional fees, video and voice session fees, deposit account fees, deposit account reward system fees and rewards points, interactive voice setup fees, or live operator assistance fees.

9. A session boarder controller (SBC) server comprising:
at least one processor configured to:
receive session data including identifying information on parties to be involved in a session;
receive carrier rate data including information related to a plurality of carriers and transport and termination costs of the plurality of carriers;
determine a lowest session rate based on the session data and the carrier rate data; and
route the session by way of at least one of the plurality of carriers based on the determined lowest session rate.

10. The SBC server of claim 9, wherein the carrier rates include information regarding contracted rates between a correctional facility and carriers.

11. The SBC server of claim 10, wherein the carrier rates further include information regarding session routing of the carriers.

12. The SBC server of claim 9, wherein the at least one processor is further configured to receive quality of service data and to further determine the lowest session rate based on the quality of service data.

13. The SBC server of claim 12, wherein the quality of service data is data based on at least one of quality tests on previous sessions, quality surveys of previous sessions, or carrier provided data.

14. The SBC server of claim 9, wherein the at least one processor is further configured to determine the lowest session rate based on at least one of correction facility fees, jurisdictional fees, video and voice session fees, deposit account fees, deposit account reward system fees and rewards points, interactive voice setup fees, or live operator assistance fees.

15. An inmate communication system, comprising:
an inmate session processor (ICP) server configured to receive session data from one of an inmate communication device or an outsider communication device, and to transmit the session data to at least one of a plurality of session boarder controller (SBC) servers; and
a first SBC server from the plurality of SBC servers configured to receive the session data from the ICP server, to determine a session rate based on the session data and carrier data, and route a session based on the determined session rate.

16. The inmate communication system of claim 15, further comprising a second SBC server from the plurality of SIC servers configured to receive the session data, to determine the session rate, and to route the session based on the determined session rate when the first SBC server is offline.

17. The inmate communication system of claim 16, wherein the first SBC server is located at a location different than a location of the second SBC server

18. The inmate communication system of claim 17, wherein the ICP server is further configured to monitor a status of the first SBC server and transmit the session data to the second SBC server when the first SBC server goes offline.

19. The inmate communication system of claim 15, wherein the first SBC server comprises a first plurality of servers configured to monitor an online status of each other, and wherein when a status of one of the first plurality of servers goes offline another one of the first plurality of servers performs tasks assigned to the offline server.

20. The inmate communication system of claim 15, further comprising a first network switch connected to each of the first plurality of servers, wherein the first network switch is configured to receive data from the ICP server and transmit the data to one of the first plurality of servers.
